(19) United States
(12) Patent Application Publication
(10) Pub. No.: US 2009/0049346 A1
(43) Pub. Date: Feb. 19, 2009

(54) Processes and Systems for Auditing Educational Data

(76) Inventor: Shawn T. Bay, Fairfield, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/190,284

(22) Filed: Aug. 12, 2008

Related U.S. Application Data
(60) Provisional application No. 60/955,658, filed on Aug. 14, 2007.

(51) Int. Cl. G06F 11/07

(52) U.S. Cl. 714/57; 714/E11.025

(57) ABSTRACT

Processes and systems for auditing educational system data developed at the school, district, state, and federal levels are disclosed. In some embodiments, the processes include the following: reviewing and validating the data; configuring the types of audits to run against the data and designating each audit as either a standard or follow-up scan thereby developing a data review; starting the data review to detect data anomalies; and notifying responsible agencies of the data anomalies. In some embodiments, the systems include the following: a data checking module for reviewing and validating the data; a data review module for configuring the types of audits to run against the data and designating each audit as either a standard or follow-up scan thereby developing a data review; an audit module for running data reviews to detect data anomalies; and a reporting module for notifying responsible agencies of the data anomalies.

### BACKGROUND OF THE INVENTION

(1) Field of the Invention

The present invention generally relates to a process for screening data. In particular, the present invention is directed to a process and system for auditing educational data.

(2) Background

The expression “garbage in, garbage out” is commonly used in reference to data systems. Even the most sophisticated data warehouse and data cleansing systems, rule changes, unheeded warnings, and new rules can create data anomalies.

Existing educational data systems generally utilize cumbersome methods for reviewing data and do not include sufficient follow-up mechanisms for identifying repeat errors. In addition, known educational data systems are typically inflexible and do not allow users to develop and run customized auditing routines.

### SUMMARY OF THE INVENTION

One aspect of the invention is a process for auditing educational system data developed at the school, district, state, and federal levels. The process includes reviewing and validating the data; configuring the types of audits to run against the data and designating each audit as either a standard or follow-up scan thereby developing a data review; starting the data review to detect data anomalies; and notifying responsible agencies at the school, district, state, and federal levels of the data anomalies.

Another aspect of the invention is a system for auditing educational system data developed at the school, district, state, and federal levels. The system includes a data checking module for reviewing and validating the data; a data review module for configuring the types of audits to run against the data and designating each audit as either a standard or follow-up scan thereby developing a data review; an audit module for running data reviews to detect data anomalies; and a reporting module for notifying responsible agencies at the school, district, state, and federal levels of the data anomalies.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is a flow diagram according to embodiments of the disclosed subject matter.

### DETAILED DESCRIPTION

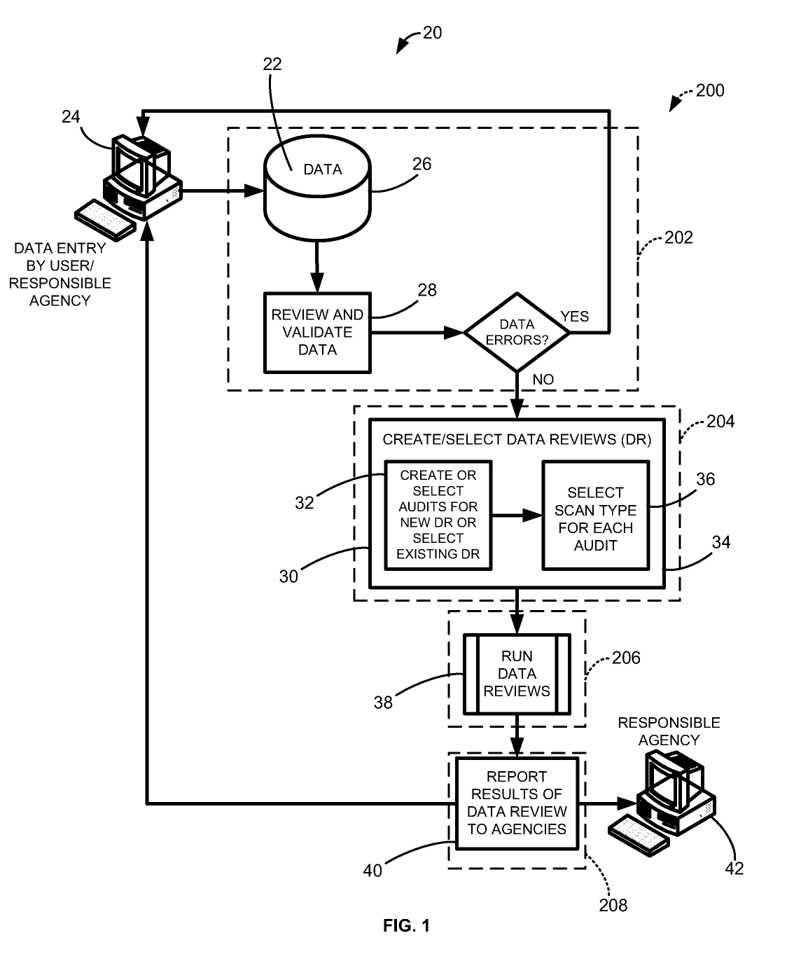

Referring now to FIG. 1, one aspect of the disclosed subject matter is a process 20 for auditing educational system data 22, e.g., student enrollment data, faculty data, etc., developed and input by a user 24 at any one of the school, district, state, and federal levels. In one embodiment, user 24 inputs data 22 via a web interface and the data are stored in database 26. Database 26 is generally used to store data input to process 20 and any data created by process 20, e.g., audit results, copies of reports, etc. Typically, but not always, data 22 is submitted using a pre-defined file format. Next, at 28, data 22 to be audited are reviewed and validated for data errors, e.g., a required field is null, etc. If any data errors are detected, user 24 is provided with appropriate feedback, including field names and line numbers, so that the user can repair the errors. To facilitate correction of errors, in some embodiments, user 24 can view actual student IDs. If no data errors are detected, user 24 is directed to step 30.

At 30, user 24 configures, i.e., selects or creates at 32, the types of audits to run against data 22. Audits to be run simultaneously against data 22 are grouped and organized in a set called a data review 34. At 32, user 24 can select an existing individual audit, create an individual audit, define a new data review 34, or select an existing pre-defined data review. At 36, user 24 designates each audit as either a standard or a follow-up scan. A standard scan audits data 22 for first time data anomalies and a follow-up scan audits the data for data anomalies that have been identified in a prior audit(s)/data review(s). The follow-up scan will identify errors that have been identified in previous audits. To qualify as a previous error, it generally must involve the same district and the same student.

The following are examples of a follow-up scan:
On October 1, the client runs a false drop-out audit and identifies a problem with student 1234567890 in ABC District. The district is notified of the error and asked to repair it.
On November 1, the client runs another false drop-out audit against an updated set of data. If the system finds that student 1234567890 is still classified as having dropped out of ABC District, it will again notify that district again and advise that the problem was previously reported.

The benefit of the follow-up scan is to provide clients with the ability to identify those districts that are not repairing their data in a timely manner. With this information, clients can work with those districts more closely, help them repair errors more quickly, and even advise on avoiding errors in the future.

At 38, user 24 runs the selected data review or individual audit to detect any data anomalies. Some embodiments of process 20 include mechanisms for allowing user 24 to check the status and view any anomalies already found in data 22 for a data review that is in progress. In addition, some embodiments provide user 24 with the ability to stop, restart, or cancel an individual audit or the entire data review at any time prior to completion.

If anomalies are found, at 40, process 20 notifies responsible agencies 42 at the school, district, state, and federal levels and/or user 24. Even if no anomalies are found, process 20 typically will notify at least user 24 of the results of the data review. Process 20 can be configured to notify agencies via an email that can be customized by user 24. The email typically will include a report of the data review results. The email and report generally include enough information so that the agency can repair the data anomalies.

In some embodiments, the audits include a simultaneous enrollment audit for finding students who are enrolled in two or more districts at the same time. The way the system does this is by comparing the records across a state to see if there are any overlapping enrollment dates.

The following is an example of the simultaneous enrollment audit:

| | | Enrollment | Enrollment |
|---|---|---|---|
| Student ID | District | Start Date | End Date |
| 1234567890 | ABC District | Jul. 01, 2006 | Aug. 05, 2006 |
| 1234567890 | XYZ District | Aug. 01, 2006 | Aug. 15, 2006 |

The primary benefit to finding these types of enrollments is funding. Each district's funding depends on the number of students that are enrolled in the district at any point in time. Finding simultaneously enrolled students will reduce the instances where a client is funding a student twice.

In some embodiments, the audits include a false drop-outs audit for finding students who were listed as dropped-out but have subsequently shown up somewhere else in the state. Essentially, the false drop-outs audit will put the previous district on notice that the student has not actually dropped out and that they should update the student's enrollment records.

The following is an example of the false drop-outs audit:

| | | Enrollment | Enrollment | Enrollment |
|---|---|---|---|---|
| Student ID | District | Start Date | End Date | Exit Code |
| 1234567890 | ABC | Jul. 01, 2006 | Aug. 01, 2006 | Left school; |
| | District | | | first-time |
| | | | | dropout |
| 1234567890 | XYZ | Sep. 02, 2006 | — | — |
| | District | | | |

The benefit of this audit is that it can reduce the number of drop-outs that a state and a district each must report. The number of drop-outs is a negative metric that can reflect negatively on the state/district. Also, it can affect the amount of funding that the agency receives.

In some embodiments, the audits include a disappearing students audit for finding students who were enrolled in a district at the end of a first year but cannot be found in the state the next year. The disappearing students audit will put the prior district on notice that the student either has not properly enrolled for the current year or has not properly exited and that it should update the student's enrollment information.

The following is an example of a disappearing students audit:

| | | Enrollment | Enrollment | Enrollment |
|---|---|---|---|---|
| Student ID | District | Start Date | End Date | Exit Code |
| 1234567890 | ABC District | Jul. 01, 2006 | — | — |

No Record Found

The primary benefit of this audit is to make sure that each student is properly accounted for over time.

In some embodiments, process 20 includes additional functionality for helping users manage data reviews. The results of recent or archived data reviews can be viewed online. Users can resend all reports for an entire data review or resend reports to individual agencies. Users can view the email details for an agency, e.g., when and how many times a particular audit report was emailed to an agency.

Another aspect of the disclosed subject matter is a system 200 for auditing educational system data developed at the school, district, state, and federal levels. System 200 includes a data checking module 202, a data review module 204, an audit module 206, and a reporting module 208.

Data checking module 202 includes processes for reviewing and validating the data and notifying a user of data errors. Data review module 204 is used to configure the types of audits to run against the data and designate each audit as either a standard or a follow-up scan. A user develops or selects a previously developed data review via data review module 204. Audit module 206 is used to run data reviews developed or selected in data review module 204 to detect data anomalies. Reporting module 208 is used to notify responsible agencies at the school, district, state, and federal levels whether any data anomalies were found and information to facilitate repair of the anomalies.

Although the invention has been described and illustrated with respect to exemplary embodiments thereof, it should be understood by those skilled in the art that the foregoing and various other changes, omissions and additions may be made therein and thereto, without parting from the spirit and scope of the present invention. Accordingly, other embodiments are within the scope of the following claims.

What is claimed is:

1. A process for auditing educational system data developed at school, district, state, and federal levels, said process comprising:
reviewing and validating the data;
configuring the types of audits to run against the data and designating each audit as either a standard or follow-up scan thereby developing a data review;
starting the data review to detect data anomalies; and
notifying responsible agencies at the school, district, state, and federal levels of the data anomalies.

2. A process according to claim 1, wherein the audits include a simultaneous enrollment audit for finding students who are enrolled in two or more districts at the same time.

3. A process according to claim 1, wherein the audits include a false drop-outs audit for finding students who were listed as drop-outs but have subsequently shown up somewhere else the state.

4. A process according to claim 1, wherein the audits include a disappearing students audit for finding students who were enrolled in a district at the end of a first year but cannot be found in the state the next year.

5. A process according to claim 1, wherein a standard scan checks the data for first time data anomalies.

6. A process according to claim 1, wherein a follow-up scan checks the data for data anomalies that have been identified in a prior data review.

7. A system for auditing educational system data developed at school, district, state, and federal levels, said system comprising:
a data checking module for reviewing and validating the data;
a data review module for configuring the types of audits to run against the data and designating each audit as either a standard or follow-up scan thereby developing a data review;
an audit module for running data reviews to detect data anomalies; and
a reporting module for notifying responsible agencies at the school, district, state, and federal levels of the data anomalies.
